(19) United States
(12) Patent Application Publication
(10) Pub. No.: US 2006/0111995 A1
(43) Pub. Date: May 25, 2006

(54) Interface between seller and buyer in seller-financed mortgages for property located in a different country from the buyer

(76) Inventor: Chittaranjan V. Reddy, Peoria, IL (US)

Correspondence Address: PILLSBURY WINTHROP SHAW PITTMAN LLP, P.O. BOX 10500, MCLEAN, VA, 22102, US

(21) Appl. No.: 11/031,247

(22) Filed: Jan. 6, 2005

Related U.S. Application Data
(60) Provisional application No. 60/630,999, filed on Nov. 24, 2004.

(51) Int. Cl. G06Q 40/00

(52) U.S. Cl. 705/35

(57) ABSTRACT

A method of providing a useful and novel interface between a buyer and a seller of a property that is seller-financed with at least one of these entities being located in a geographically different location from the property. Through this interface the seller is guaranteed prompt payments and the buyer can be provided all the provisions needed for a financial benefit, such as tax deductions on the mortgage interest (paid on an offshore immovable property) and would be assisted in all regulations, tax or otherwise, in the country of the purchased property.

### CROSS-REFERENCE TO RELATED APPLICATIONS

This application claims the benefit of priority under 35 U.S.C. § 119(e) from U.S. Provisional Patent Application No. 60/630,999 filed on Nov. 24, 2004, and entitled “Interface Between Seller and Buyer in Seller-Financed Mortgage for Property Located in a Difference Country from the Buyer”.

### BACKGROUND OF THE INVENTION

The present invention relates to a business method for financial transactions and, more specifically, to seller-financed mortgages for immovable property.

Seller-financed mortgages offer some unique advantages to both the seller and the buyer. Typically, the seller, the buyer, and the subject immovable property are geographically co-located. Accordingly, seller-financed mortgages are not uncommon when dealing with immovable property when the seller and buyer live in the same country. On the other hand, the seller, buyer and property may not be in the same geographical location. For example, the seller may be in one location, the buyer in a second location and the subject property in a third location. Each of these locations may be geographically remote.

There are advantages and disadvantages for the seller in a seller-financed transaction. The seller can often obtain a higher rate of return within a seller-financed mortgage than with other potential investments outside the mortgage. However, from the seller's perspective there is uncertainly, especially if the seller will become or is geographically remotely located from the subject property. Other problems include the uncertainty regarding the buyer's financial background and not being certain of receiving mortgage payments in a timely fashion.

There are advantages and disadvantages for the buyer in a seller-financed transaction. For example, the buyer may have difficulty in securing financing through conventional avenues. Another reason that the buyer would choose seller-financing would include the seller offering terms to the buyer, such as duration of mortgage and/or principal amounts, which may not be available through financial institutions. Accordingly, a seller-financed loan and the additional options it offers would be a solution to the buyer's problems. However, interest rates tend to be higher with seller-financed mortgages than what are typically available with larger financial institutions. Additionally, from the buyer's perspective, uncertainty regarding rights to the property and losing such rights in case of brief irregularity in mortgage payments, are of concern.

Another potential problem, for both the seller and the buyer is triggered by the buyer's failure to make timely payments that may require selling the property to a neutral party at a ridiculously low price. This is disadvantageous to both the initial seller and buyer. These potential problems are compounded if the buyer and seller live in different countries.

Thus, what is needed is a method for allowing a seller-financed transaction to take place while at the same time providing both the buyer and the seller with certain assurances, regardless of the geographical location of the seller and buyer relative to the property.

### SUMMARY OF THE INVENTION

A method is disclosed that provides for a seller-financed transaction that takes place while at the same time providing both the buyer and the seller with certain assurances, regardless of the geographical location of the seller and buyer relative to the subject immovable property.

### BRIEF DESCRIPTION OF THE DRAWINGS

These and other aspects and features of the present invention will become apparent to those of ordinary skill in the art upon review of the following description of specific embodiments of the invention in conjunction with the accompanying Figures, wherein:

FIG. 1 is a flow diagram illustration of the process of providing a seller-financed transaction in accordance with the present invention;

FIG. 2 is a configuration of the business model of FIG. 1; and

FIG. 3 is a flow process in accordance with the present invention.

### DETAILED DESCRIPTION

Embodiments of the present invention will now be described in detail with reference to the drawings, which are provided as illustrative examples so as to enable those skilled in the art to practice the invention. Notably, the figures and examples below are not meant to limit the scope of the present invention. Where certain elements of these embodiments can be partially or fully implemented using known components, only those portions of such known components that are necessary for an understanding of the present invention will be described, and detailed descriptions of other portions of such known components will be omitted so as not to obscure the invention. Further, the present invention encompasses present and future known equivalents to the components referred to herein by way of illustration.

In accordance with the teachings of the present invention, a neutral party becomes a titleholder and acts as an interface whose objectives will be advantageous to both the buyer and the seller. The neutral party would be holding the “sale agreement” drafted between the seller and the buyer until the conditions in the agreement have been actualized or both parties willfully retract from the “sale agreement”. This method also provides a means for financial transactions through the internet between seller and buyer related to the immovable property across two different countries. For example, mortgage payments would be made periodically using a secured website. The buyer would be issued a “Form-1098” on behalf of the seller. Taxpayers in the United States who want to buy property outside the United States can benefit largely.

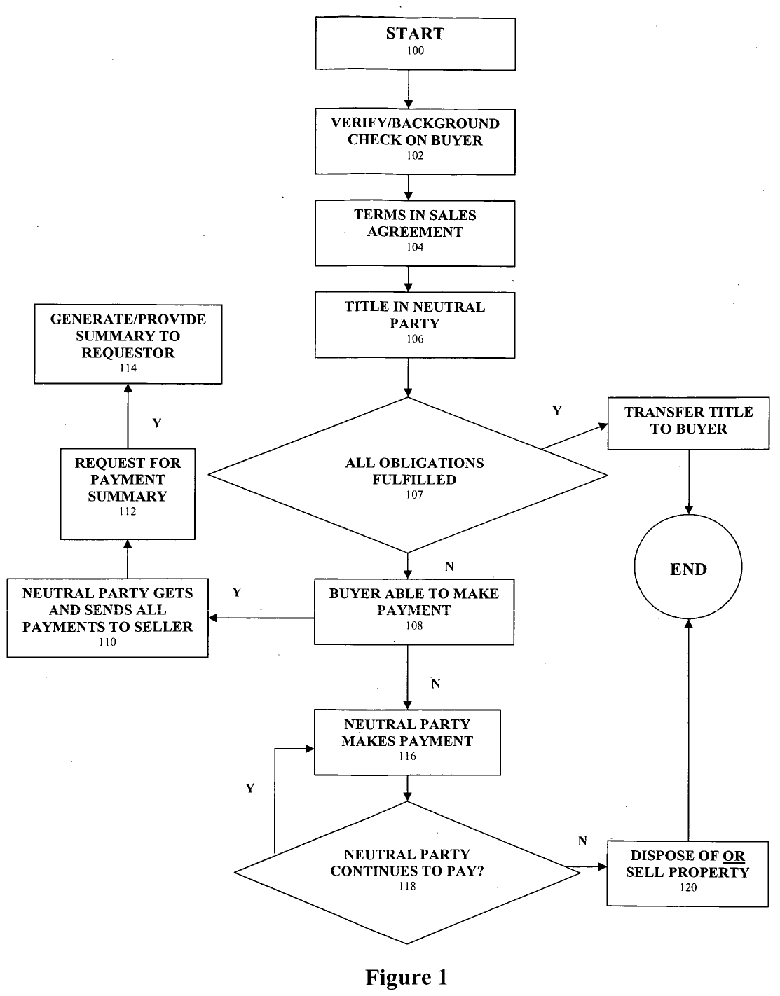

Referring now to FIG. 1, the process in accordance with the present invention begins at step 100. At step 102, the buyer's financial background will be thoroughly evaluated by a neutral party. In one embodiment the buyer completes an application that provides the neutral party with the necessary information to complete the investigation. Such an application can be completed on-line or electronically using a secured link that can only be accessed by the neutral party or the neutral parties authorized representative. The intervention of the neutral party will allow for the risk of financing the buyer to be more accurately assed by the seller because the information that the neutral party can obtain is something that may not be possible for the seller to do himself. At step 104, the transaction is formalized in a sales agreement consistent with all legal procedures in the seller's country or in the country where the subject property is located; which ever may be most beneficial to the transaction. The sales agreement contains the conditions and obligations, such as the mortgage duration and interest rate, to be fulfilled by the seller and the buyer. From the date the legal document has been signed by both the seller and the buyer, the immovable property in subject would then be held as property “mortgaged with possession” by the neutral party.

At step 106, official title to the subject property would be held by the neutral party along with the legal document that describes the terms of the obligation. The neutral party would continue to hold title to the property until the conditions and obligation set forth in the sale agreement or legal document have been fulfilled and actualized. Thus, at step 107 the neutral party determines if the buyer and seller have both fulfilled their obligations. If so, then the neutral party would transfer title to the property into the name of the buyer in accordance with the requirements of the sale agreement. On the other hand if at step 107, it is determined that the obligations of the parties have not been fulfilled, such as the buyer still needs to make payments, then the process proceeds to step 108.

At step 108, it is determined if the buyer has made a payment based on the terms of the sales agreement. Payments made by the buyer towards this mortgage would be monitored by and sent directly to the neutral party. One form of collecting the payment includes the use of a secure link between the buyer and the neutral party. For example, the buyer logs onto his account available on a secure internet website or a secure network. Comprehensive account details would be available to the buyer at all times. Through this online account the buyer can transfer funds from his personal banking account, credit card, or by check to the neutral party's account, which can be located in a different or the same bank/financial institution. Alternatively, these funds can be automatically transferred through a secured socket layer (SSL) on a monthly basis. Any number of other secure methods of transferring money can be used to transfer the funds from the buyer to the neutral party and the scope of the present invention is not limited thereby.

If at step 108 it is determined that the buyer has made a payment, then at step 110 the funds are transferred to the seller's account in his bank. Whenever the buyer transfers money from his account to the neutral party, the details would be stored in the neutral party's random access database. The buyer can be sent an email confirming his payment has been received. Once the payment has been transferred to the seller's account, he would be notified again.

At step 112, the neutral party determines if it is time to prepare a summary of the payments by the buyer or if the buyer has requested a summary of the payments. With complete knowledge of payments, including interest payments, made by the buyer, the neutral party would provide the buyer with a “Form 1098” and all other documentation needed for potential tax benefits. If the buyer is located in a country other than the US, then the neutral party can provide the appropriate tax related documentation for that specific country Furthermore, this information is especially useful for the buyer because interest on a mortgage for residential or investment property, even if outside the United States, is eligible for deduction from income earned by US taxpayers. If at step 112 it is determined that a summary is necessary, then a step 114 a summary is provided to the requestor or if the summary is needed for tax reasons, then the summary is sent to the appropriate party or parties.

If at step 108 it is determined that the buyer has failed to make a payment. For example, unforeseen circumstances may prevent the buyer from making the mortgage payments in a timely fashion. If the buyer has not made payments, then at step 116 the neutral party would forward payments on the buyer's behalf to the seller for a specified period of time, as determined by the neutral party and buyer to enable a favorable resolution of the business transaction to the mutual benefit of both the seller and buyer. The two possible outcomes would be that the buyer's financial situation would improve, allowing him to continue with the mortgage schedule.

At step 118 it is determined if the neutral party should continue to make payments. If so, then the process returns to step 116 where the neutral party makes the payment. On the other hand, if at step 118 the neutral party determines that the buyer is unable to continue and no more payments will be made, then at step 120 the property can be disposed under terms that would be favorable to both the initial buyer and seller.

At some point the seller may wish to sell his mortgage to another party, so that he may receive his remaining funds immediately. The neutral party would serve as the first option to buy the property; thus, the seller can easily sell his mortgage.

Certain benefits and advantages are disclosed herein for the seller of the property, including: thorough due diligence is done regarding the buyer who is from a different country from the seller; guarantee the seller of his rights (liens) over the specific immovable property and the interest until the seller receives total payment on the “seller-financed mortgage”; guaranteed payments in a timely fashion, including the possibility of making payments on behalf of the buyer in case of unforeseen financial circumstances; the neutral party would be the first option for buying the mortgage from the seller in case the seller wanted all of his money earlier.

Certain benefits and advantages are disclosed herein for the seller of the property, including: buyer would receive property title promptly once the conditions of the sale agreement have been actualized; ensure that the property and sale agreement conform to rules and regulations in the country of the property; assure the buyer's payments (on his behalf) for a specified period in case of any unforeseen financial events that prevent the buyer from making the payments, which would allow for a more favorable financial settlement of the property and the previous sale agreement; the buyer (and seller as needed) would be furnished annually or as requested with provisions (such as an annual ‘Form 1098’ when buyer is in the United States) towards tax deductions on the interest paid in the stated mortgage.

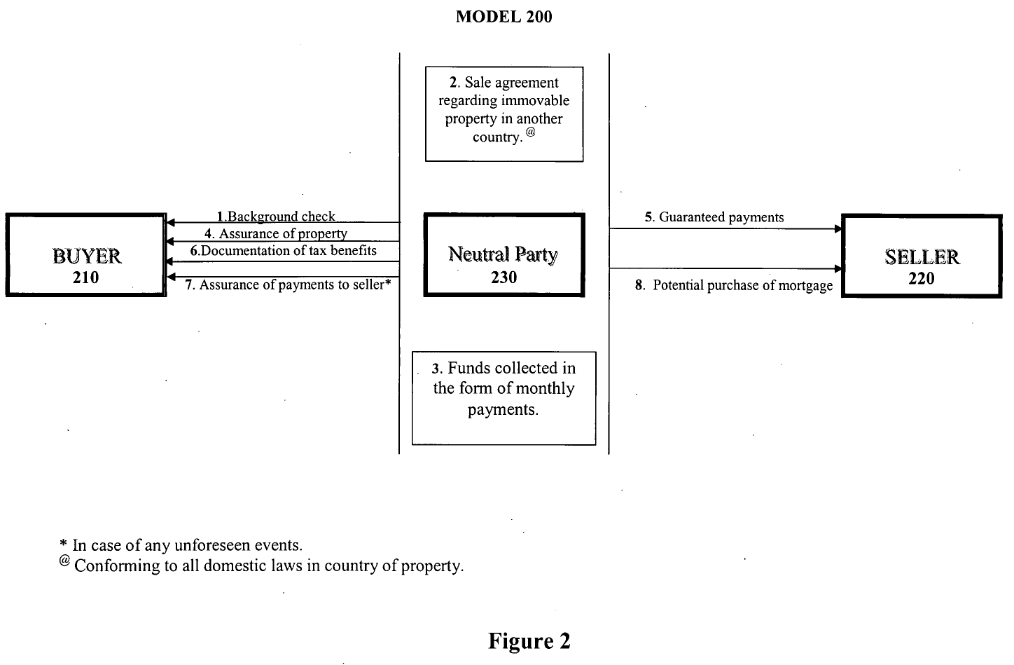

Referring now the FIG. 2, the relationship model 200 includes a buyer 210, a seller 220, and a neutral party 230. The relationship between the buyer 210 and the neutral party 230 includes various components of the transaction. For example, the neutral party 230 can perform a background check on the buyer 210. Additionally, the neutral party 230 can collect funds from the buyer 210 in the form of monthly payments, provide the buyer 210 with certain assurances related to property, provide the buyer 210 with the necessary summary of payments made for the purpose of taxation and upon request, and act as an assurance to the seller 220 in the event the buyer 210 is temporarily unable to make the payments or fulfill his obligations. Additionally, the neutral party 230 would hold title to the property on behalf of the buyer 210 until all of the obligations set forth in the sales agreement are fulfilled.

The relationship between the seller 220 and the neutral party 230 includes several aspects or components that form part of the transactions. First, the neutral party 230 would guarantee that the buyer 210 would make all necessary payments. Second, the neutral party 230 would be the holder of the title to the property so that the seller 220 would not risk losing title to the property in case the buyer 210 does not fulfill all obligations under the terms of the sales agreement, such as making all of the payments. The neutral party 230 would also be a potential purchaser of the mortgage payment due to the seller 220.

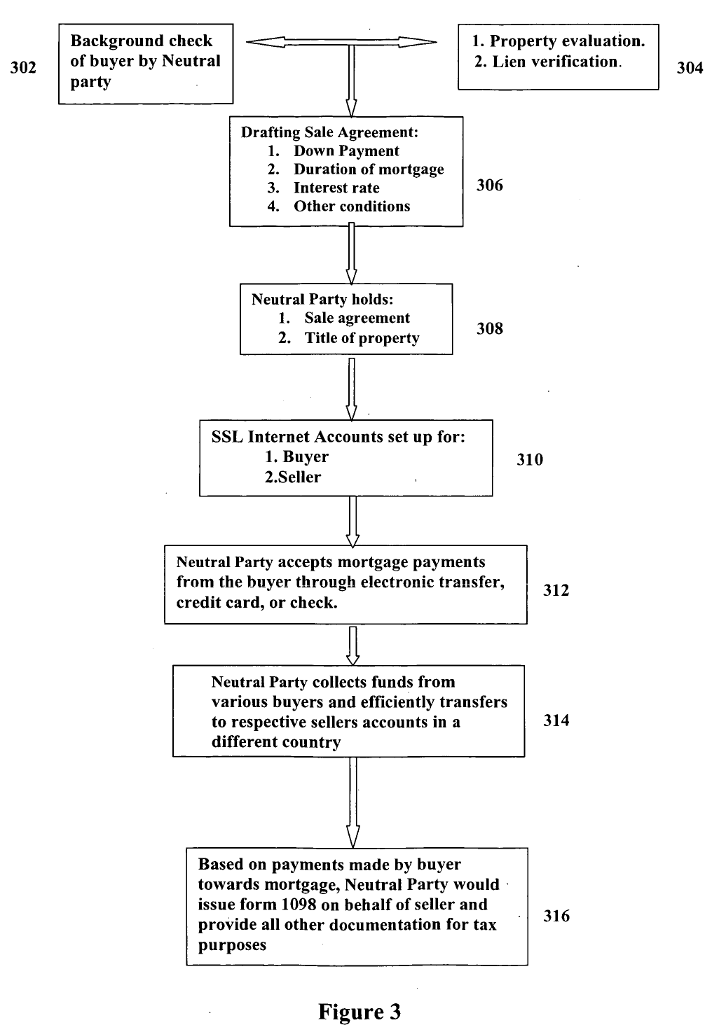

Referring now to FIG. 3, a process 300 includes the steps of performing a background check 302 and evaluation of the property 304, including lien verification. At step 306 a sales agreement is prepared, that includes information about down payment, duration of mortgage, interest rate, and other conditions. At step 308, a neutral party hold the legal tile to the property as well as the sales agreement needed to enforce the rights of the either the seller or the buyer. At step 310 an account is set up for the buyer and the seller for handling the transfer of funds. At step 312 the neutral party accepts payments from buyer in any acceptable form. At step 314 the neutral party takes the funds collected from the buyer as well as other buyers that are under a sale agreement with the seller and forwards the funds to the seller. At step 316 and as necessary the neutral party generates summaries and tax forms relating to the payments made by the buyer for the buyer as well as a summary for payments received by the seller for the seller.

The above embodiments may be altered in many ways without departing from the scope of the invention. Further, the invention may be expressed in various aspects of a particular embodiment without regard to other aspects of the same embodiment. Still further, various aspects of different embodiments can be combined together. Accordingly, the scope of the invention should be determined by the following claims and their legal equivalents.

What is claimed is:

1. A process of providing an interface for a seller-financed property located in a country that is different from a buyer's country of taxation, the process comprising the steps of:
assessing the background of the buyer;
transferring title for the property to a neutral party;
collecting payments for the seller from the buyer, such that the neutral party guarantees that buyer will make payments and that the seller will receive payments when the buyer does not make a timely payment; and
providing at least the buyer with a payment summary that can be used by the buyer to gain a financial benefit.

2. The process of claim 1 wherein the step of collecting payments includes collecting payments electronically over a network.

3. The process of claim 1 wherein the step of collecting payments includes collecting payments electronically over a secured dedicated network.

4. The process of claim 1 wherein the step of assessing includes the steps of:
receiving information about the buyer over a secured network; and
evaluating the risk associated with financing the buyer.

5. A method for benefiting a seller and a buyer of a property through a neutral party, the method comprising the steps of:
receiving background information about the buyer over a secure network accessible by the neutral party in order to determine the risk of financing the buyer;
receiving title to the property from the seller;
receiving at least one payment from the buyer through the secure network, wherein the payment is delivered to the seller;
providing at least the buyer with a summary that allows the buyer to benefit financially from certain regulatory benefits available in the buyer's country.

6. The method of step 5 further comprising the step of creating an account for the seller, wherein the account is accessible by the neutral party and the seller and the payment is delivered to the account.

7. The method of claim 6 further comprising the step of crediting at least one substitute payment to the seller's account from the neutral party on behalf of the buyer when the buyer is not able to make a scheduled payment to the seller.

8. The method of claim 6 comprising the step of accessing the account using a secure network.

9. The method of claim 6 comprising the step of accessing the account through a public network using a password.

10. The method of step 5 further comprising the seller transferring the seller's right to the payment to the neutral party and receiving full benefit for the property such that thereafter the neutral party receives and keeps future payments from the buyer.
